(19) United States
(12) Patent Application Publication
(10) Pub. No.: US 2005/0035878 A1
(43) Pub. Date: Feb. 17, 2005

(54) Early warning system for approaching emergency vehicle

(75) Inventor: Vladimir Vassilevsky, Perry, OK (US)

Correspondence Address: VLADIMIR VASSILEVSKY, 1405 LOCUST, PERRY, OK, 73077, US

(73) Assignee: Vladimir Vassilevsky, Perry, OK (US)

(21) Appl. No.: 10/917,392

(22) Filed: Aug. 13, 2004

Related U.S. Application Data
(60) Provisional application No. 60/494,741, filed on Aug. 14, 2003.

(51) Int. Cl. G08G 1/00

(52) U.S. Cl. 340/902

(57) ABSTRACT

A warning system that alerts motorists and pedestrians of the approaching emergency vehicles is disclosed. The system consists of the devices mounted on the emergency vehicles and stationary or portable devices. The stationary devices are mounted along the roads and each includes a receiver, a processor and a warning signal. The portable or wearable receivers are mounted inside the vehicles or carried by pedestrians. The system can operate by four different methods: a) Broadcasting the navigation data (coordinates, velocity and heading) from the emergency vehicle b) Using the directional transmitter mounted on the vehicle and directed forward c) Using the distance finder from the emergency vehicle to the fixed part d) Using the identification device which allows to detect and distinct the emergency vehicles from other traffic

The present invention relates to systems to avoid traffic hazards from the emergency vehicles. In particular, the present invention relates to a warning system to alert motorists and pedestrians about the incoming emergency vehicle, so they can take an action to avoid the potential hazard.

### BACKGROUND

Emergency vehicles, such as law enforcement, fire-fighter trucks, and ambulances have to reach the place of an emergency as soon as it is possible. That requires traveling at high speeds when on alert. The emergency vehicles should be given the priority over all other kinds of traffic.

Traditionally, the audible and visible signals such as sirens and flashes are used on the emergency vehicles to inform all other participants of the traffic, so they can give a right to an incoming emergency vehicle. In many cases, the range of conventional signals appears to be insufficient to alert other drivers in advance. The examples of this type of situation are when the road comes across the hilly terrain, or has turns or other obstructions. There are also the situations involving hearing impaired persons, loud ambient noise, wind blowing the siren sound out of the way, playing music with high volume in the car, and loss of attention. That creates a potentially dangerous situation, when an unsuspecting vehicle is suddenly approached by the emergency vehicle moving at a high speed.

The useful range of conventional audible and visible signals of the emergency vehicle can not be significantly extended by applying more powerful light and sound sources. The flashes are limited to the unobstructed line of sight. The high volume audio signals are very annoying to the emergency vehicle crew and the driver, and also representing a risk of the hearing loss.

There have been other approaches to address the problem. The system disclosed in U.S. Pat. No. 6,160,493 to Smith uses the radio transmitter mounted on the emergency vehicle to alert the other traffic participants. The drivers and pedestrians are required to have the appropriate individual receivers for the system to be operable. The range of the system depends on the transmit power and the radio propagation conditions, which may result in the false alerting on the adjacent streets or roads.

Accordingly there is a need for a system which extends the range of audible and visible warning signals of an emergency vehicle. The system components are required to be mounted on the emergency vehicles and in the streets.

### SUMMARY OF THE INVENTION

The object of the present invention is to improve the safety of operation for emergency vehicles, as well as all other traffic in the area, providing advance information of the incoming emergency vehicle to the drivers and pedestrians. The proposed system is based on the warning devices deployed along the roads.

The other object of the present invention is to provide the warning only in the areas where the emergency vehicle is heading to, and with the appropriate timing with the accordance to the emergency vehicle speed.

The other object of the present invention is the warning system which operates by three possible methods or any combination of these methods:
1. Using the vehicle-based navigation system, which determines the vehicle coordinates, velocity and heading, and transmits it to the warning devices in the area. So, the warning devices are on once the emergency vehicle is entering the corresponding pre-programmed geographic areas.
2. Using the vehicle based directional transmitter, which triggers the warning devices in advance on the way of the emergency vehicle.
3. Using the distance finder device, that detects the distance from the emergency vehicle to the warning area.
4. Using the device, that identifies the emergency vehicle passing by, and triggers the remote warning signals on the way of the vehicle.

### BRIEF DESCRIPTION OF THE DRAWINGS

FIG. 1 illustrates the principle of operation of the present invention using the onboard navigation system.

FIG. 2 illustrates the principle of operation of the present invention using the directional transmitter.

FIG. 3 illustrates the operation of the preset invention using the distance finder.

FIG. 4 illustrates the principle of operation of the present invention using the identification device.

### DESCRIPTION OF A PREFERRED EMBODIMENT

An emergency vehicle such as a police car on alert is heading in a certain direction along the road. The direct propagation of the flash light and siren sound is obstructed and can't be noticed in advance by the other vehicles and the pedestrians. The emergency vehicle is speeding and it is going to pass the other vehicles in the short period of time. That creates hazardous situation because the vehicles and pedestrians may not have enough time to get out of the way of the incoming emergency vehicle.

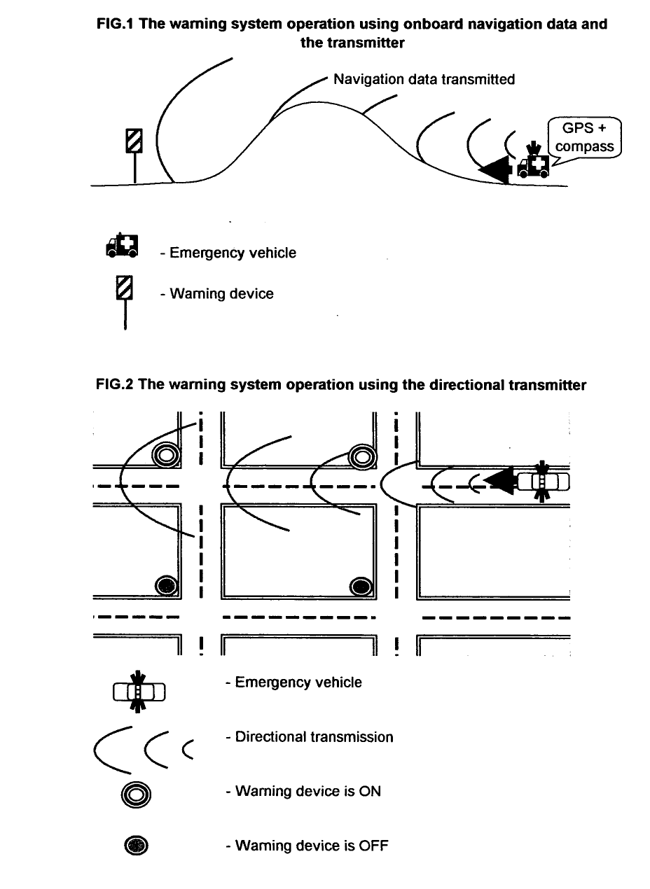

The principle of operation of the present invention using the onboard navigation system is illustrated in FIG. 1. The transmitter of the emergency vehicle broadcasts the information from the navigation system, which includes course, geographic coordinates and the speed. The example of such navigation system may be a combination of GPS receiver and electronic magnetic compass. The warning device located on the pole receives this broadcast and interprets it. Once the emergency vehicle enters the area of a particular warning device, the warning device sounds a siren, lights on the flashlight or provides any other suitable means of indication, so all of the traffic participants are alerted about the incoming emergency vehicle.

The operation of the present invention using the directional transmitter is depicted in FIG. 2. The emergency vehicle is equipped with the directional transmitter, which emits a signal directly ahead. The transmitter may be an RF, acoustic or optical device. An example of such transmitter may be the police speed radar. The signal of the directional transmitter is detected at much farther distance, then the direct reach of the siren sound and the flash light. Once the signal is detected, the warning device is switched on.

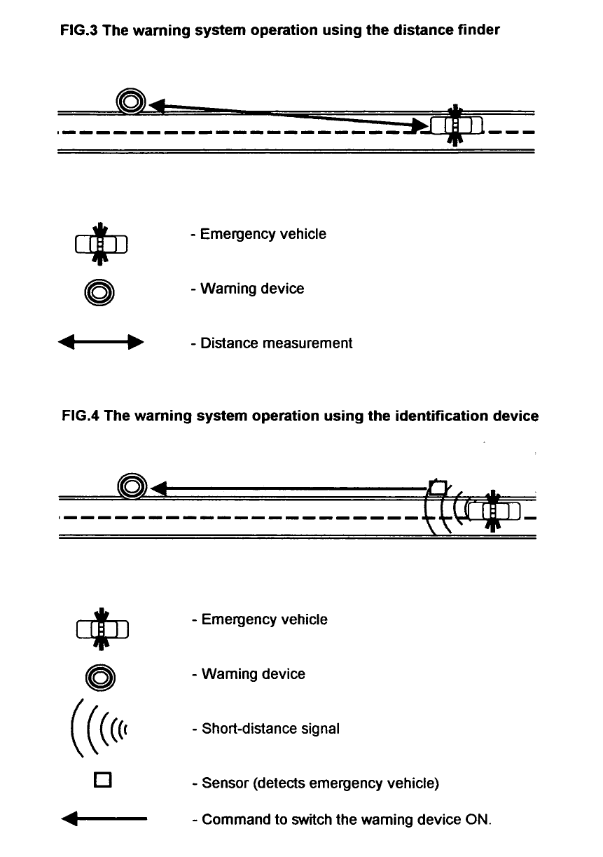

The operation using the distance finder system is depicted in FIG. 3. The wireless distance finder system continuously monitors the distances from the emergency vehicle to the warning devices within a reach. The distance finder may operate as follows. The vehicle transmits a challenge signal. The warning devices are responding to the challenge by sending their responses back to the vehicle. The response turnover delays determine the distances to the emergency vehicle. Then, the vehicle transmits the distances back to the warning devices. Each warning device is checking the distance. If the distance is gradually decreasing, the estimated time of arrival of the emergency vehicle is calculated. If the ETA falls below the pre-programmed limit, the warning signal is activated.

FIG. 4 illustrates operation of the system using an emergency vehicle identification device. The short range identification device, such as RFID, is installed on the road in advance to the warning device. The identification device selects the emergency vehicles on alert from all other kinds of traffic. Any kind of active or passive responder identification system may be used. Once the emergency vehicle is detected, the warning signal is switched on.

The warning system may operate using either of above described methods or any combination of these methods, which allows for significant flexibility in deployment and the operating characteristics.

The additional function of the warning system may be a control for traffic light preemption. If the incoming emergency vehicle is detected, and the direction it comes from is known, the output of the system may be used for a traffic light preemption purpose.

The system may be also equipped with portable or wearable receivers mounted inside the vehicles or carried by the users. Those receivers may receive the alerting information either transmitted directly from the emergency vehicle or from the nearest warning device.

While certain embodiments of the present invention have been described above, the present invention is not limited to these. There may any variations, combinations and modifications of the ways and methods of operation of the warning system. The description is considered to be of illustrative purpose and the invention is to be limited by the claims.

1. A system which extends the range of visible and audible alert signals of approaching emergency vehicles consisting of the vehicle mount part and the remote warning signal devices mounted in the streets.

2. A warning system for approaching emergency vehicles, which utilizes either of the following means:
a) An onboard navigation system of an emergency vehicle, which is used to determine the vehicle coordinates, velocity, and course and transmit this information to the warning devices using the vehicle-based transmitter.
b) The directional transmission from the emergency vehicle, which is used to trigger the warning devices on the path of the emergency vehicle.
c) The direct distance measurement between the emergency vehicle and the warning device.
d) The vehicle detectors, which distinguish the emergency vehicles on alert from other kinds of traffic.
